(19) United States
(12) Patent Application Publication
(10) Pub. No.: US 2003/0223352 A1
(43) Pub. Date: Dec. 4, 2003

(54) Reduction of forward crosstalk using time division multiplexing

(76) Inventor: Ricki Dee Williams, Temecula, CA (US)

Correspondence Address: Meyertons, Hood, Kivlin, Kowert & Goetzel, P.C., P.O. Box 398, Austin, TX, 78767-0398, US

(21) Appl. No.: 10/157,276

(22) Filed: May 29, 2002

(51) Int. Cl. H04J 15/00; H04Q 7/00

(52) U.S. Cl. 370/201; 370/314

(57) ABSTRACT

A method and system for reducing forward crosstalk using time division multiplexing of the crosstalk noise. The method includes routing a plurality of signal lines along generally parallel paths and spacing one or more groups of the plurality of signal lines unequally in a neck in and a neck out configuration so that adjacent signal lines in each of the one or more groups of the plurality of signal lines extend away from each other within a predetermined distance. The method may also include terminating each of the plurality of signal lines using active termination. The method may also include establishing a single strip line stack up.

### BACKGROUND OF THE INVENTION

1. Field of the Invention

This invention relates generally to computer systems, and, more particularly, to a method and apparatus for reducing forward cross talk, such as in a tightly routed printed circuit board.

2. Description of the Related Art

Network computing has increased dramatically over the past several years due in part to the emergence of the Internet. Some trends in the industry include a significant growth in Applications Service Providers (ASPs) that provide applications to businesses over networks that use the Internet, for example, to distribute product data to customers, take orders, and enhance communications between employees.

Typically, businesses rely on network computing to maintain a competitive advantage over other businesses. As such, developers typically consider several factors to meet the customer's expectation when designing processor-based systems for use in network environments. Such factors, for example, may include functionality, reliability, scalability, and the performance of these systems.

Modern electronic equipment such as processor-based computer systems used in a network environment is highly complex and expensive. The drive to lower cost while adding new functionality has lead many manufacturers to shrink the size of integrated circuits, printed circuit boards, also known as printed wiring boards, and other electronic components as well as the connectors and connections that link the electronic components.

Miniaturization, used to avoid cost problems, may lead to other problems, including different cost problems. Engineering design constraints for miniaturized systems, devices, and components such as heat transfer, power plane droop, mutual induction, etc., may lead to increased costs for design and manufacturing. Cost concerns notwithstanding, the market demands smaller and more complex electronics.

The production of such complex computer system may also lead to problems in routing the large number of signal traces in and on printed circuit boards. Induction of a noise signal on a nearby signal trace is caused when the electromagnetic field from a signal on another signal trace is sufficiently large. This phenomenon is known as forward crosstalk when the noise signal is induced from the leading edge of a propagating signal.

### SUMMARY OF THE INVENTION

In one aspect of the present invention, a method is provided. The method includes routing a plurality of signal lines along generally parallel paths and spacing one or more groups of the plurality of signal lines unequally in a neck in and a neck out configuration so that adjacent signal lines in each of the one or more groups of the plurality of signal lines extend away from each other within a predetermined distance. In various embodiments, the method further includes terminating each of the plurality of signal lines using active termination. In some embodiments, the method further includes establishing a single strip line stack up.

In another aspect of the present invention, a computer readable medium encoded with instructions is provided, which when executed by a computer system performs a method. The method includes routing a plurality of signal lines along generally parallel paths and spacing one or more groups of the plurality of signal lines unequally in a neck in and a neck out configuration so that adjacent signal lines in each of the one or more groups of the plurality of signal lines extend away from each other within a predetermined distance. In various embodiments, routing the plurality of signal lines along generally parallel paths includes routing the plurality of signal lines among connections to one or more active components and one or more passive components. In other embodiments, routing the plurality of signal lines along generally parallel paths includes routing the plurality of signal lines along generally parallel paths such that the plurality of signal lines are substantially symmetrical about a point of symmetry.

In still another aspect of the present invention, a system is provided. The system includes means for conveying data signals and means for routing ones of the means for conveying data signals along generally parallel paths. The system also includes means for spacing one or more groups of the means for conveying data signals unequally in a neck in and a neck out configuration so that adjacent ones of the means for conveying data signals extend away from each other within a predetermined distance. In various embodiments, the system also includes means for actively terminating each of the means for conveying data signals. In other embodiments, the system also includes means for signal and power distribution.

In yet another aspect of the present invention, another system is provided. The system includes a backplane and a plurality of signal lines routed along generally parallel paths. The plurality of signal lines is divided into one or more groups of signal lines. Within each group of the one or more groups of signal lines, the signal lines are spaced unequally in a neck in and a neck out configuration so that adjacent signal lines extend away from each other within a predetermined distance. In various embodiments, the system also includes active terminators coupled to each of the plurality of signal lines. In other embodiments, the backplane comprises a single strip line stack up.

### BRIEF DESCRIPTION OF THE DRAWINGS

The invention may be understood by reference to the following description taken in conjunction with the accompanying drawings, in which like reference numerals identify like elements, and in which:

FIG. 1 illustrates a stylized block diagram of an embodiment of a surface of a printed wiring board in accordance with one aspect of the present invention;

FIG. 2 shows a block diagram of an embodiment of a portion of a cross section of the printed wiring board of FIG. 1, according to one aspect of the present invention;

FIG. 3 illustrates a block diagram of an embodiment of a section of signal trace runs showing a neck out, according to one aspect of the present invention;

FIG. 4 illustrates a block diagram of an embodiment of a section of signal trace runs showing neck in and neck out, according to one aspect of the present invention;

FIG. 5 illustrates a block diagram of an embodiment of a section of signal trace runs showing a center of symmetry, according to one aspect of the present invention; and

FIG. 6 illustrates a flowchart of a method of operating a computer system, according to one embodiment of the present invention.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed, but, on the contrary, the intention is to cover all modifications, equivalents, and alternatives falling within the spirit and scope of the invention as defined by the appended claims.

### DETAILED DESCRIPTION OF SPECIFIC EMBODIMENTS

Illustrative embodiments of the invention are described below. In the interest of clarity, not all features of an actual implementation are described in this specification. It will of course be appreciated that in the development of any such actual embodiment, numerous implementation-specific decisions must be made to achieve the developers' specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure. Note that not all aspects of the present invention are included in each embodiment of the present invention.

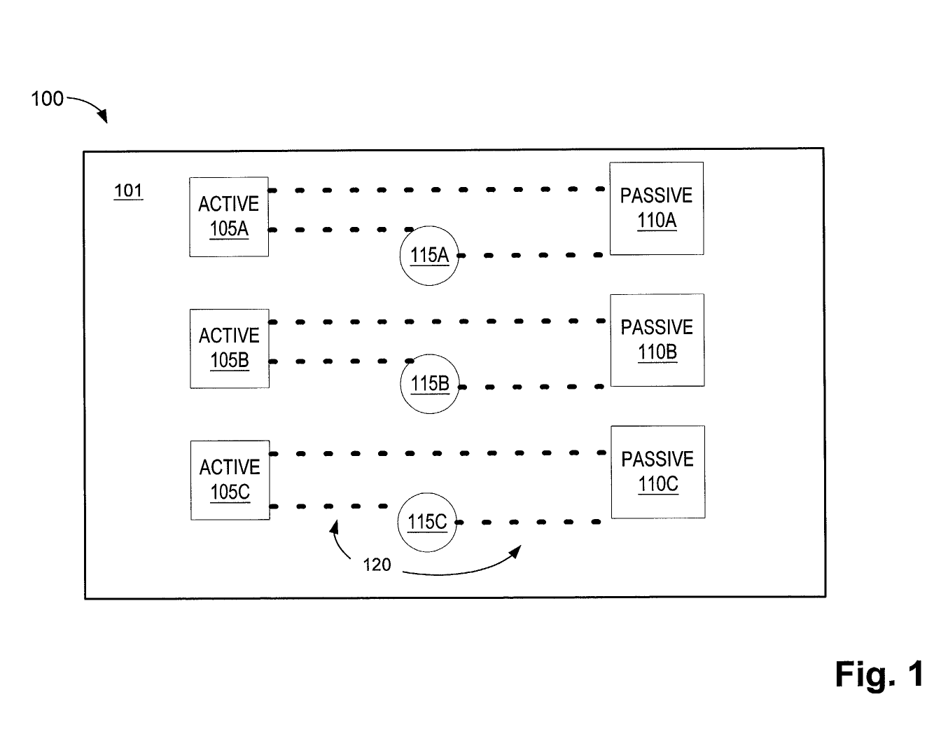

Turning now to the drawings, and specifically referring to FIG. 1, a stylized block diagram of an embodiment of a surface 101 of a printed wiring board 100 in accordance with one aspect of the present invention is shown. As shown, the printed wiring board 100, also referred to as a backplane 100, includes a plurality of active components 105A, 105B, and 105C, a plurality of passive components 110A, 110B, and 110C, a plurality of switches 115A, 115B, and 115C, and indications for signal lines 120.

The active components 105A-105C may represent any number and/or type of active components 105 known to be placed on the backplane 100. The passive components 110A-110C may represent any number and/or type of passive components 110 known to be placed on the backplane 100. Active and passive components 105, 110 are typically distinguished in the art by power or current production or draw. Examples of active components 105 include processors, memories, power supplies, controllers, and integrated circuits. Examples of passive components 110 include resistors, capacitors, inductors, etc. While the illustrated embodiment shows a specific number of active components 105 and passive components 110, the figure is stylized to illustrate a concept and not specific in type, number, or interconnections. The present invention may be used with any number and types of active components 105 and passive components 110, including all active components 105, all passive components 110, or any combination between these extremes. There may be no active components 105 and no passive components 110 where only signal routing is being used.

The switches 115A-115C are provided as a means of interconnecting the active components 105 and the passive components 110 in a variety of ways. In the illustrated embodiment, the switches 115 are cross bar switches implemented as a plurality of high-speed integrated circuits.

The indications of signal traces 120, also referred to as signal lines 120, are used to illustrate the concept of generally parallel signal traces 120. Note that preplanning for the placement of each component 105, 110 and each switch 115 may allow for adequate spacing for generally parallel signal traces 120 in accordance with various aspects of the present invention described herein in various embodiments. For the purposes of this disclosure, the term “generally parallel” is used when two lines are parallel to a substantially complete extent except where another design feature results in a change in separation distance of the two lines. In one embodiment, each signal trace is actively terminated in an attempt to minimize backwards crosstalk from a reflected signal.

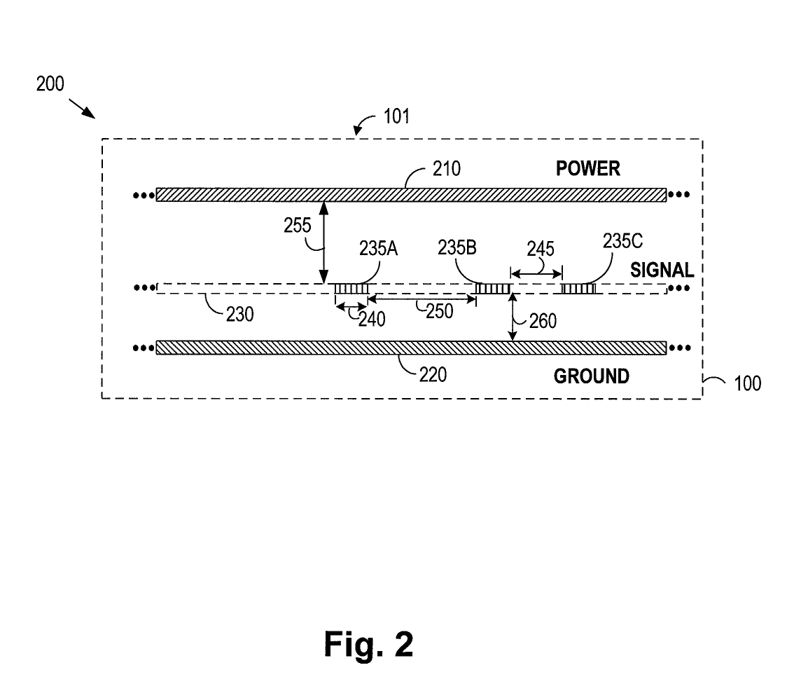

FIG. 2 shows a block diagram of an embodiment of a portion of a cross section 200 of the printed wiring board 100 of FIG. 1, according to one aspect of the present invention. In the illustrated embodiment, the orientation of the cross section 200 is with the bottom of FIG. 1 being the side facing the viewer in FIG. 2. Other orientations not inconsistent with various aspects of the present invention are also contemplated.

In the illustrated embodiment of FIG. 2, the cross section 200 includes a power plane 210, a ground plane 220, and a signal plane 230. The signal plane 230 includes a plurality of signal lines 235A, 235B, and 235C. The signal lines 235A, 235B, and 235C are each of width 240. The signal line 235A is separated from the signal line 235B by a distance 250. The signal line 235B and the signal line 235C are separated by a distance 245. The power plane and the signal plane are separated by a distance 255. The signal plane and the ground plane are separated by a distance 260. Note that the distance 255 is larger than the distance 260. The distance 250 is larger than the distance 245.

The cross section 200 represents a single strip line stackup with a single signal plane 230 between the power plane 210 and the ground plane 220. The stackup is asymmetrical with the signal plane 230 closer to the ground plane 220 than the power plane 210. The distance 245 represents a minimum distance between adjacent signal lines 235 in a particular implementation.

At the distance 245, signal induction from the adjacent signal line 235 will tend to occur while as the signal propagates along the adjacent signal line 235. The distance 250 represents a distance over which the signal induction from the adjacent signal line 235 is lessened. Various aspects of the present invention contradict conventional wisdom that forward cross-talk perturbations add algebraically as the length of the signal lines increase.

In various embodiments, the signals transmitted over the signal lines 235 are clocked with various clock rates. In one embodiment, the clock rate is 150 MHz. Other clock rates are contemplated, and the present invention is not limited to any particular clock rate. The predetermined magnitude of distances 245, 250 between signal lines 235 may also vary among different embodiments. The distances 245, 250 will have predetermined magnitudes based on the implementation. Representative distances 245, 250 include three (3) mil (width 240) signal lines 235 with five (5) mil minimum spacing, such as represented by distance 250. As the distances 245, 250 are illustrative only, they may be measured from center-to-center or edge-to-edge, as desired, with appropriate conversion to take differences in definitions into account.

Various implementations of the present invention may approach 100% utilization of available board space with forward crosstalk voltage levels approximately 40% of typical values or lower. Various embodiments may also include various design features not necessary for the operation or understanding of the present invention but used in the art. Those design features include, but are not limited to, buried vias, platted thru-hole finished vias, and via anti-pads. Note that a given backplane 100 may include one or more single strip line stackups. For example, the backplane 100 might be described as having 24 signal planes and 24 power planes. When configured as single strip line stackups, each of the 24 signal planes would be between the 24 power planes and 24 ground planes.

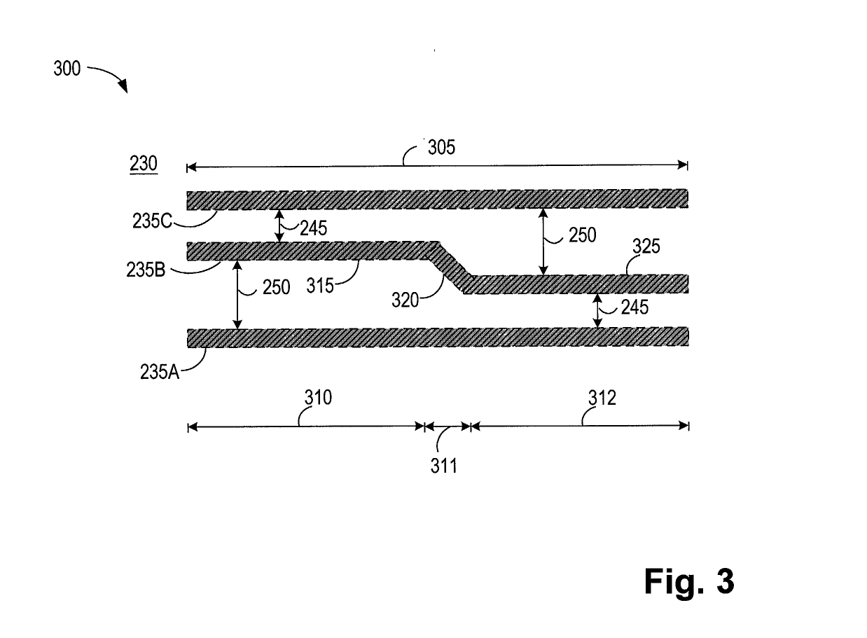

FIG. 3 illustrates a stylized cross sectional top view of an embodiment of a section 300 of signal trace runs on the signal plane 230, showing a neck out 320, according to one aspect of the present invention. The signal traces 235A, 235B, and 235C are shown in a top view of the signal plane 230, compared to the cross sectional view in FIG. 2. The signal traces 235A and 235C are shown as straight. The signal trace 235B is shown with a section 315, the neck out 320, and a section 325.

The signal trace 235A and the section 315 of the signal trace 235B are the distance 250 apart at the left edge of the section 300, while the signal trace 235B and the section 325 of the signal trace 235C are the distance 250 apart at the right edge of the section 300. The section 315 of the signal trace 235B and the signal trace 235C are the distance 245 apart at the left edge of the section 300, while the signal trace 235A and the section 325 signal trace 235B are the distance 245 apart at the right edge of the section 300. The length of the signal traces 235A and 235C is shown as length 305, while the length of the sections 315 and 325 is shown as length 310.

According to one aspect of the present invention, the length 305 represents a length of adjacent signal traces where an induced signal may be at or near a predetermined maximum noise level if the adjacent signal traces 235 are of the length 305 at the spacing 245. The length 310 represents a predetermined fraction of the length 305. The length 310 is chosen so as to maintain a predetermined level of noise induction in any adjacent signal traces 235. According to the usage of this disclosure, the signal traces 235A, 235B, and 235C are all considered to be substantially straight and generally parallel. The angle between section 315 and the neck out 320 of the signal trace 235B may be chosen to maintain the substantially straight nature of the signal line 235B. As shown, the angle is approximately 45 degrees, although other angles and geometries may be used and are contemplated. Note that the section 300 is an example of three signal lines 235 spaced over an area large enough for four signal lines 235.

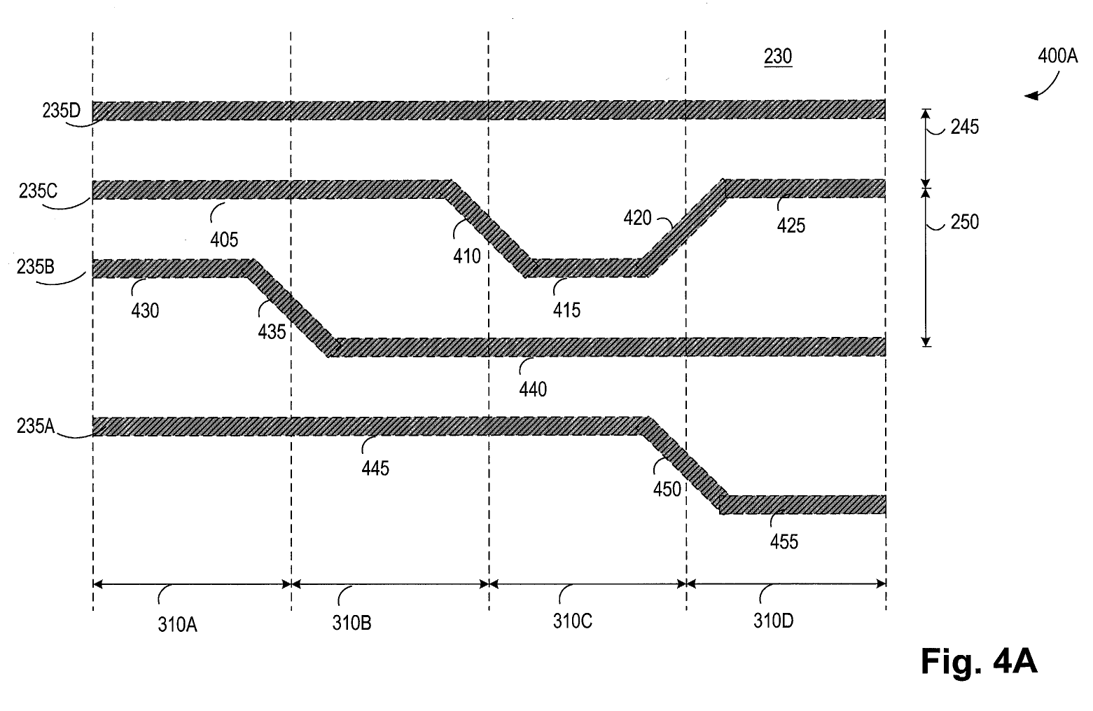

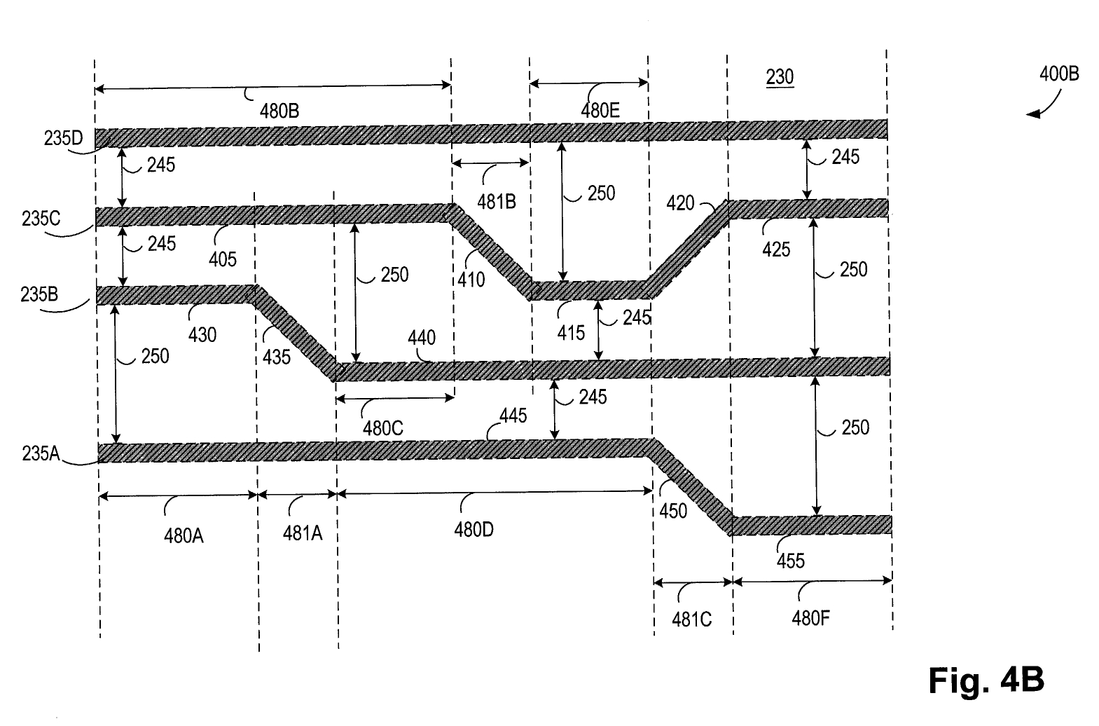

FIG. 4A illustrates a stylized cross sectional top view of an alternative embodiment of a section 400A of signal lines 235A-235D on the signal plane 230 showing neck ins and neck outs 410, 420, 435, and 450, according to one aspect of the present invention. The signal lines 235A, 235B, 235C are shown along with a signal line 235D in a four signal line configuration spaced over an area large enough for six signal lines 235. The signal line 235D in section 400 is shown as a straight line with a length 405 across distances 310A, 310B, 310C, and 310D. The signal line 235C includes a section 405 across the distances 310A and 310B and a neck out 410 extending away from the signal line 235D that is also a neck in extending towards the signal line 235B in a transition from the distance 310B to the distance 310C.

The signal line 235C also includes a section 415 across the distance 310C, a neck in 420 extending towards the signal line 235D in a transition from the distance 310C to the distance 310D, and a section 425 across the distance 310D. The signal line 235B includes a section 430 across the distance 310A, a neck out 435 extending away from the signal line 235 C in a transition from the distance 310A to the distance 310B, a section 440 across the distances 310B, 310C, and 310D. The signal line 235A includes a section 445 across the distances 310A, 310B, and 310C, a neck out 450 extending away from the signal line 235B at a transition from the distance 310C to the distance 310D, and a section 455 across the distance 310D.

At closest, adjacent signal lines 235A and 235B, 235B and 235C, and 235C and 235D are the distance 245 apart. At farthest, adjacent signal lines 235A and 235B, 235B and 235C, and 235C and 235D are the distance 250 apart. The distances between adjacent signal lines 235 may vary between the distance 245 and the distance 250 during neck ins and neck outs 410, 420, 435, and 450.

FIG. 4B illustrates a stylized cross sectional top view of an alternative embodiment 400B of the section 400A of signal lines 235A-235D on the signal plane 230 showing neck ins and neck outs 410, 420, 435, and 450, according to one aspect of the present invention. Except as otherwise indicated, the section 400B is the same as the section 400A.

The signal line 235A includes a segment of length 480A, a segment of length 481A, a segment of length 480D, a transition with a projection length 481C, and a segment of length 480F. The signal line 235B includes a segment of length 480A, a transition with a projection length 481A, a segment of length 480C, a segment of length 481B, a segment of length 480E, a segment of length 481C, and a segment of 480F. The signal line 235C includes a segment of length 480A, a segment of length 481A, a segment of length 480C, a transition with a projection length 481B, a segment of length 480E, a transition with a projection length 481C, and a segment of length 480F. The signal line 235D includes a segment of length 480B, a segment of length 481B, a segment of length 480E, a segment of length 481C, and a segment of length 480F.

For the purposes of this disclosure, the segments in a configuration corresponding to that of the segments of signal line 235D having lengths 480B and 481B are considered contiguous, while the segments in a configuration corresponding to the segments of signal line 235C having lengths 480C and 480E are considered not contiguous. In addition, for the purposes of this disclosure, segments in a configuration corresponding to the segment of signal line 235A with length 480A form a “set” with the segment (i.e., the section 430) of the signal line 235C also with the length 480A. Another way to define a “set” is adjacent segments of different signal lines 235 with the same length.

As noted above, at closest, adjacent signal lines 235A and 235B, 235B and 235C, and 235C and 235D are the distance 245 apart. At farthest, adjacent signal lines 235A and 235B, 235B and 235C, and 235C and 235D are the distance 250 apart. The distances between adjacent signal lines 235 may vary between the distance 245 and the distance 250 during transitions (e.g., neck ins and neck outs 410, 420, 435, and 450), shown here each having a projection length 481 when the transition is projected onto the adjacent segment of the adjacent signal line 235. Note that the transitions are not limited to lines, but may also be S-type curves or other shapes.

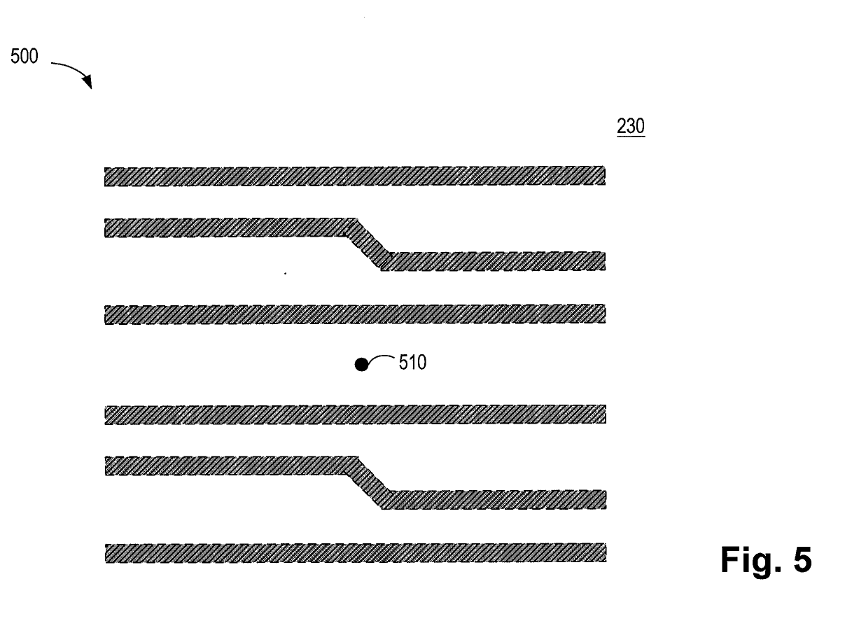

FIG. 5 illustrates a stylized cross sectional top view of an alternative embodiment of a section 500 of signal trace runs on the signal plane 230 showing a center of symmetry 510, according to one aspect of the present invention. The center of symmetry 510 is a position where the signal traces are substantially symmetric about the point 510. The symmetry shown in FIG. 5 may minimize some crosstalk in the signal plane 230 as whole, according to one aspect of the present invention.

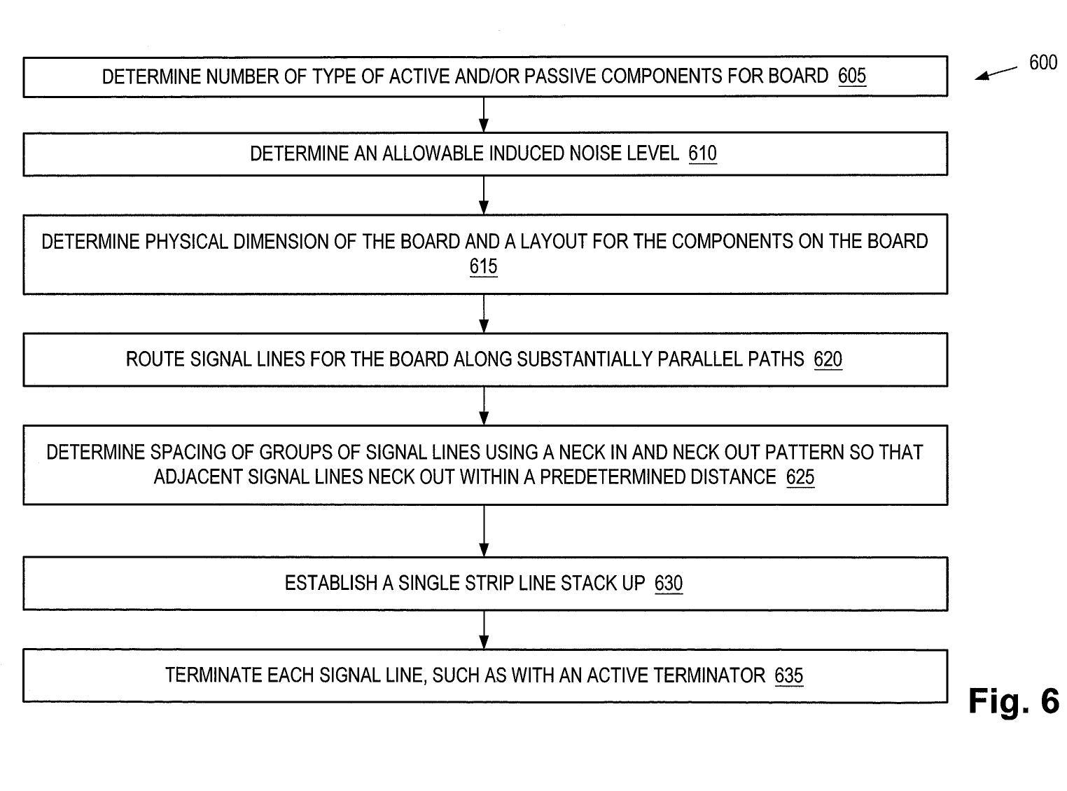

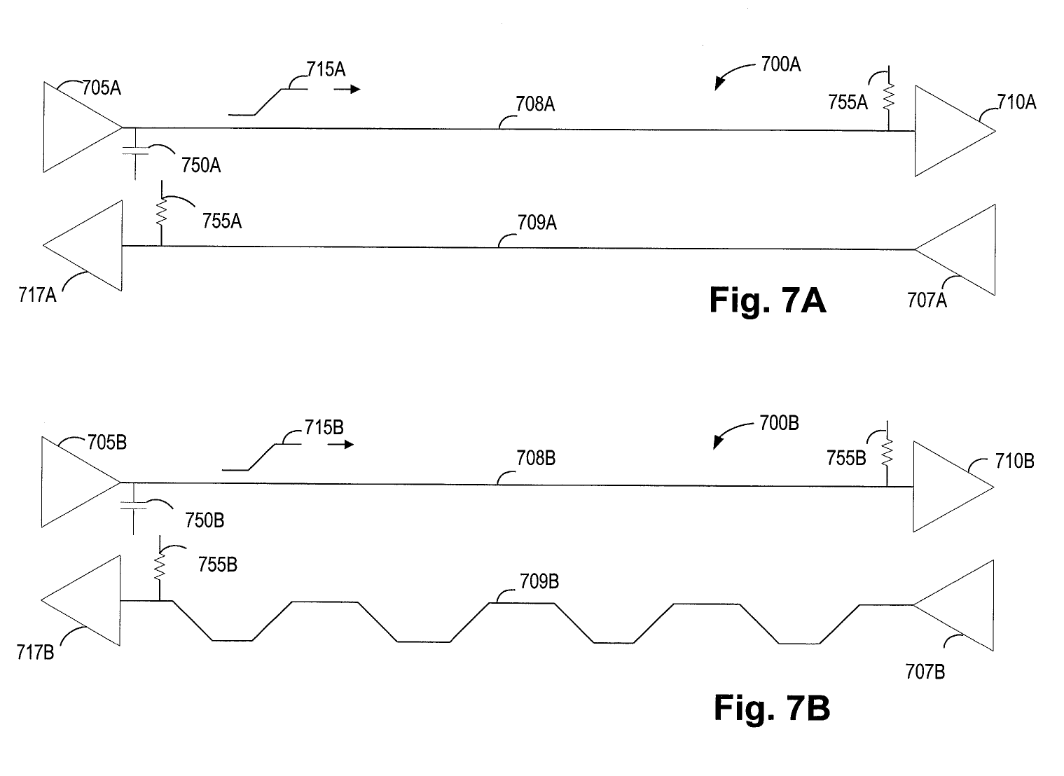

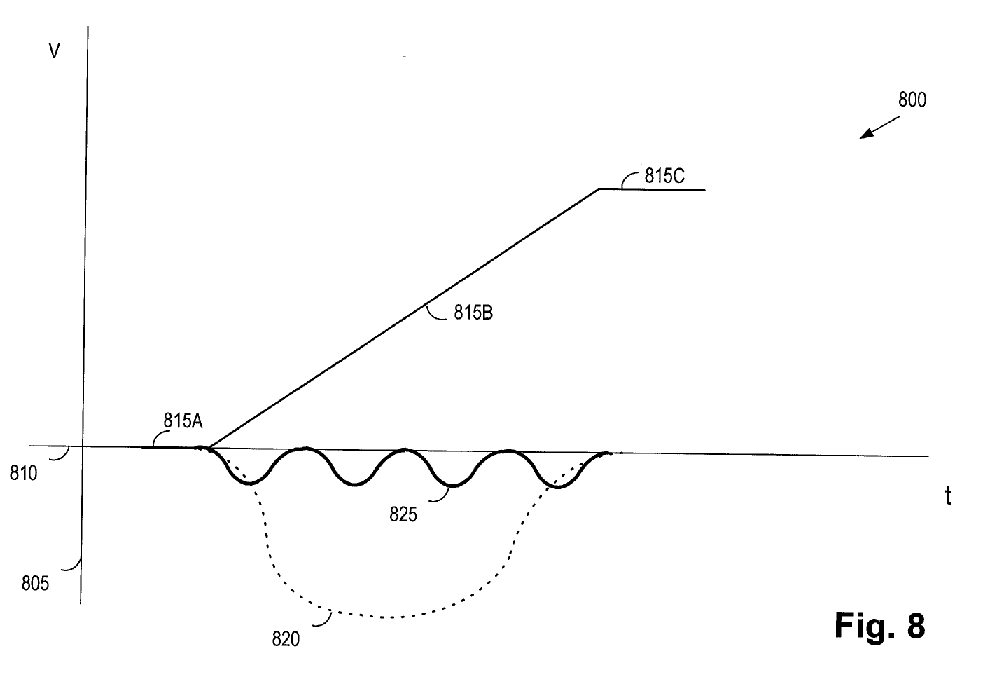

FIG. 6 illustrates a flowchart of an embodiment of a method 600 of designing the backplane 100, according to one embodiment of the present invention. The method 600 may also be modified slightly to become a method of operating the backplane 100. The method 600 includes determining a number and type of the active components 105 and/or the passive components 110 for the backplane 100, in block 605. The method 600 also includes determining an allowable induced noise level, in block 610. The allowable induced noise level may be calculated using predetermined operating parameter ranges for the backplane 100. In one embodiment, an acceptable fraction of the allowable induced noise level may be determined.

The method 600 also includes determining the physical dimensions of the backplane 100 and a layout, or positioning, for the components, both active 105 and passive 110, on the backplane 100, in block 615. The method also includes routing the signal lines 235 between and/or among the components, both active 105 and passive 110, or the connections thereto, so that the signal lines 235 are substantially straight and generally parallel, block 620.

The method 600 also includes determining a spacing and a grouping of the signal lines 235 using a neck in and neck out pattern so that adjacent signal lines 235 extend away within a predetermined distance such as the distance 310, in block 625. The method also includes establishing a single strip line stack up, such as the embodiment shown in FIG. 2, in block 630. Other embodiments of single strip line stack ups are also contemplated. The illustrated embodiment in FIG. 2 is asymmetrical in the distances 255 and 260 between the signal plane 230 and the power and ground planes 210 and 220, respectively. The method also includes terminating each signal line 235 with an active terminator, in block 635. The active terminator may be included in the logic used to transmit and receive the signals over the signal lines 235 or a separate component.

Note that while the method 600 of the present invention disclosed herein has been illustrated as a flowchart, various elements of the flowcharts may be omitted or performed in a different order in various embodiments. Note also that the method 600 of the present invention disclosed herein admit to variations in implementation. Note also that the method of operating the backplane 100 mentioned above may be understood from, for example, blocks 620, 625, 630, and 635 with the signals being routed over the signal lines 235 with the spacings and terminations as described referring to the signals over the signal lines 235.

FIGS. 7A and 7B illustrate embodiments of simple topologies 700A, 700B that result in forward crosstalk when the signal line pairs 708A, 709A and 708B, 709B are close together. As shown in FIG. 7A, a first driver 705A connects to a first signal line 708A and to a first receiver 710A. The first driver 705A drives a leading edge of a signal 715A along the first signal line 708A. A second driver 707A connects to a second signal line 709A and to a second receiver 717A. For discussion purposes, a small capacitance 750A is coupled to the end of the first signal line 708A nearest the first driver 705A, and far end termination is shown by a small impedance 755A coupled to each of the end of the first signal line 708A nearest the first receiver 710A and the end of the second signal line 709A nearest the second receiver 717A.

The signal lines 708A and 709A are, for purposes of discussion, straight and parallel. The separation distance between the signal lines 708A and 709A is small enough, e.g., minimally spaced, that the leading edge of the signal 715A induces noise signal, i.e., forward crosstalk, on the signal line 709A. The small capacitance 750A acts to invert the noise signal.

As shown in FIG. 7B, a first driver 705B connects to a first signal line 708B and to a first receiver 710B. The first driver 705B drives a leading edge of a signal 715B along the first signal line 708B. A second driver 707B connects to a second signal line 709B and to a second receiver 717B. For discussion purposes, a small capacitance 750B is coupled to the end of the first signal line 708B nearest the first driver 705B, and far end termination is shown by a small impedance 755B coupled to each of the end of the first signal line 708B nearest the first receiver 710B and the end of the second signal line 709B nearest the second receiver 717B.

The signal line 708B is shown as straight, while the signal line 709B has a neck-in and neck-out configuration as described herein. The minimum separation distance between the signal lines 708B and 709B is the separation distance between signal lines 708A and 709A, i.e., small enough, e.g., minimally spaced, that the leading edge of the signal 715B induces noise signal, i.e., forward crosstalk, on the signal line 709B. The small capacitance 750B acts to invert the noise signal.

FIG. 8 shows an exemplary graph 800 of the forward crosstalk induced by an aggressor line, e.g., signal lines 708A, 708B, on a neighboring victim line, e.g., signal lines 709A, 709B, as illustrated in FIGS. 7A and 7B. The independent axis 805 is voltage (V), while the dependent axis 810 is time (t). Typical scales are millivolts or volts for the voltage if axis 805 and nanoseconds or microseconds for the time axis 810. The driver of the aggressor line is quiet 815A at first but outputs a substantially constant signal that rises linearly 815B until a maximum voltage level is reached 815C. Note that the graph 800 is generally representative of most points along the signal line, e.g., 708A, 708B, 709A, 709B. The voltage 815 rises until the leading edge 715 reaches the receiver 710 and the signal is terminated.

The noise signals 820 and 825 correspond to the induced noise signals on the neighboring victim lines 709A, 709B, respectively. The noise signal 820 is induced by forward crosstalk on the signal line 709A by the signal on the signal line 708A. The saturated coupled noise signal 820 may rise to 30% or more of the magnitude of the inducing signal 815C on the signal line 708A. The noise signal 825 is induced by forward crosstalk on the signal line 709B by the signal on the signal line 708B. The neck-in and neck-out configuration gives rise to the up and down nature of the noise signal 825. The shape of the noise signal 825 is a result of the noise signal being time division multiplexed. The saturated coupled noise signal 825 may be designed to typically rise to about 3% of the magnitude of the inducing signal 815C on the signal line 708B.

The present invention may advantageously allow for a higher density of nets than previously possible. The signal lines may be packed more densely, taking up less area than before. These traits are especially useful in switching applications for modem computer systems. Referring back to FIG. 1, consider the backplane 100 having inputs and outputs that connect many computer nodes through a plurality of address, control, and/or data crossbar switches 115. The density of the signal lines 120 may determine the minimal area of the backplane 100.

Some aspects of the present invention, as disclosed above, may be implemented in hardware, firmware, or software. Thus, some portions of the detailed descriptions herein are consequently presented in terms of a hardware implemented process and some portions of the detailed descriptions herein are consequently presented in terms of a software-implemented process involving symbolic representations of operations on data bits within a memory of a computing system or computing device. These descriptions and representations are the means used by those in the art to convey most effectively the substance of their work to others skilled in the art using both hardware and software. The process and operation of both require physical manipulations of physical quantities. In software, usually, though not necessarily, these quantities take the form of electrical, magnetic, or optical signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantifies. Unless specifically stated or otherwise as may be apparent, throughout the present disclosure, these descriptions refer to the action and processes of an electronic device, that manipulates and transforms data represented as physical (electronic, magnetic, or optical) quantities within some electronic device's storage into other data similarly represented as physical quantities within the storage, or in transmission or display devices. Exemplary of the terms denoting such a description are, without limitation, the terms “processing,” “computing,” “calculating,” “determining,” “displaying,” and the like.

Note also that the software-implemented aspects of the invention are typically encoded on some form of program storage medium or implemented over some type of transmission medium. The program storage medium may be magnetic (e.g., a floppy disk or a hard drive) or optical (e.g., a compact disk read only memory, or “CD ROM”), and may be read only or random access. Similarly, the transmission medium may be twisted wire pairs, coaxial cable, optical fiber, or some other suitable transmission medium known to the art. The invention is not limited by these aspects of any given implementation.

The particular embodiments disclosed above are illustrative only, as the invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular embodiments disclosed above may be altered or modified and all such variations are considered within the scope and spirit of the invention. Accordingly, the protection sought herein is as set forth in the claims below.

What is claimed:

1. A method for reducing forward crosstalk, the method comprising:
routing a plurality of signal lines along generally parallel paths; and
spacing one or more groups of the plurality of signal lines unequally in a variable spacing configuration so that adjacent signal lines in each of the one or more groups of the plurality of signal lines extend away from each other within a predetermined distance to reduce the forward crosstalk between the adjacent signal lines.

2. The method of claim 1, further comprising:
terminating each of the plurality of signal lines using active termination.

3. The method of claim 2, further comprising:
establishing a single strip line stack up.

4. The method of claim 3, wherein establishing the single strip line stack up comprises establishing an asymmetric single strip line stack up.

5. The method of claim 1, further comprising:
establishing a single strip line stack up.

6. The method of claim 5, wherein establishing the single strip line stack up comprises establishing an asymmetric single strip line stack up.

7. The method of claim 1, wherein routing the plurality of signal lines along generally parallel paths comprises routing the plurality of signal lines among connections to one or more active components or one or more passive components.

8. The method of claim 1, wherein routing the plurality of signal lines along generally parallel paths comprises routing the plurality of signal lines along generally parallel paths such that the plurality of signal lines are substantially symmetrical about a point of symmetry.

9. The method of claim 1, wherein spacing the one or more groups of the plurality of signal lines unequally in the variable spacing configuration so that adjacent signal lines on each of the groups of the plurality of signal lines extend away from each other within the predetermined distance to reduce the forward crosstalk between the adjacent signal lines further comprises spacing the one or more groups of the plurality of signal lines unequally in the variable spacing configuration so that adjacent signal lines on each of the groups of the plurality of signal lines extend away from each other such that less than about 50% of a predetermined induced voltage maximum value is induced on the adjacent signal lines from the forward crosstalk.

10. The method of claim 1, wherein spacing the one or more groups of the plurality of signal lines unequally in the variable spacing configuration so that adjacent signal lines on each of the groups of the plurality of signal lines extend away from each other within the predetermined distance to reduce the forward crosstalk between the adjacent signal lines further comprises spacing the one or more groups of the plurality of signal lines unequally in the variable spacing configuration so that adjacent signal lines on each of the groups of the plurality of signal lines extend away from each other within the predetermined distance with a group of the one or more groups including a first number (x) of signal lines spaced over a width sufficient for at least the first number of signal lines plus one (x+1).

11. The method of claim 1, wherein spacing the one or more groups of the plurality of signal lines unequally in the variable spacing configuration so that adjacent signal lines on each of the groups of the plurality of signal lines extend away from each other within the predetermined distance to reduce the forward crosstalk between the adjacent signal lines further comprises spacing the one or more groups of the plurality of signal lines unequally in the variable spacing configuration so that adjacent signal lines on each of the groups of the plurality of signal lines extend away from each other within the predetermined distance with a group of the one or more groups including a first number (x) of signal lines spaced over a width sufficient for at least the first number of signal lines plus two (x+2).

12. The method of claim 1, wherein spacing the one or more groups of the plurality of signal lines unequally in the variable spacing configuration so that adjacent signal lines on each of the groups of the plurality of signal lines extend away from each other within the predetermined distance to reduce the forward crosstalk between the adjacent signal lines further comprises spacing the one or more groups of the plurality of signal lines unequally in a neck in and a neck out configuration so that adjacent signal lines on each of the groups of the plurality of signal lines extend away from each other within the predetermined distance to reduce the forward crosstalk between the adjacent signal lines.

13. A system with reduced forward crosstalk, comprising:
means for conveying data signals;
means for routing ones of the means for conveying data signals along generally parallel paths; and
means for spacing one or more groups of the means for conveying data signals unequally in a variable spacing configuration so that adjacent ones of the means for conveying data signals extend away from each other within a predetermined distance to reduce the forward crosstalk between the adjacent ones of the means for conveying data signals.

14. The system of claim 13, further comprising:
means for actively terminating each of the means for conveying data signals.

15. The system of claim 14, further comprising:
means for signal and power distribution.

16. The system of claim 15, wherein the means for signal and power distribution is asymmetrical.

17. The system of claim 13, further comprising:
means for signal and power distribution.

18. The system of claim 17, wherein the means for signal and power distribution is asymmetrical.

19. The system of claim 13, wherein the means for routing the means for conveying data signals along generally parallel paths further comprises means for routing the means for conveying data signals among connections to one or more active components and one or more passive components.

20. The system of claim 13, wherein the means for conveying data signals are configured substantially symmetrical about a point of symmetry.

21. The system of claim 13, wherein during operation less than about 50% of a predetermined induced voltage maximum value is induced on the adjacent ones of the means for conveying data signals.

22. The system of claim 13, wherein during operating less than about 100 mV is induced on the adjacent ones of the means for conveying data signals.

23. The system of claim 13, wherein a group of the one or more groups includes a first number (x) of the means for conveying data signals spaced over a width sufficient for at least the first number plus one (x+1) of the means for conveying data signals.

24. The system of claim 23, wherein the first number (x) is greater than or equal to three.

25. The system of claim 13, wherein a group of the one or more groups include a first number (x) of the means for conveying data signals spaced over a width sufficient for at least the first number plus two (x+2) of the means for conveying data signals.

26. A computer readable medium encoded with instructions that, when executed by a computer system, performs a method for reducing forward crosstalk, the method comprising:
routing a plurality of signal lines along generally parallel paths; and
spacing one or more groups of the plurality of signal lines unequally in a variable spacing configuration so that adjacent signal lines in each of the one or more groups of the plurality of signal lines extend away from each other within a predetermined distance to reduce the forward crosstalk between the adjacent signal lines.

27. The computer readable medium of claim 26, wherein routing the plurality of signal lines along generally parallel paths comprises routing the plurality of signal lines among connections to one or more active components and one or more passive components.

28. The computer readable medium of claim 26, wherein routing the plurality of signal lines along generally parallel paths comprises routing the plurality of signal lines along generally parallel paths such that the plurality of signal lines are substantially symmetrical about a point of symmetry.

29. The computer readable medium of claim 26, wherein spacing the one or more groups of the plurality of signal lines unequally in the variable spacing configuration so that adjacent signal lines on each of the groups of the plurality of signal lines extend away from each other within the predetermined distance to reduce the forward crosstalk between the adjacent signal lines further comprises spacing the one or more groups of the plurality of signal lines unequally in the variable spacing configuration so that adjacent signal lines on each of the groups of the plurality of signal lines extend away from each other such that less than about 50% of a predetermined induced voltage maximum value is induced on the adjacent signal lines from the forward crosstalk.

30. The computer readable medium of claim 26, wherein spacing the one or more groups of the plurality of signal lines unequally in the variable spacing configuration so that adjacent signal lines on each of the groups of the plurality of signal lines extend away from each other within the predetermined distance to reduce the forward crosstalk between the adjacent signal lines further comprises spacing the one or more groups of the plurality of signal lines unequally in the variable spacing configuration so that adjacent signal lines on each of the groups of the plurality of signal lines extend away from each other within the predetermined distance with a group of the one or more groups including a first number (x) of signal lines spaced over a width sufficient for at least the first number of signal lines plus one (x+1).

31. The computer readable medium of claim 26, wherein spacing the one or more groups of the plurality of signal lines unequally in the variable spacing configuration so that adjacent signal lines on each of the groups of the plurality of signal lines extend away from each other within the predetermined distance to reduce the forward crosstalk between the adjacent signal lines further comprises spacing the one or more groups of the plurality of signal lines unequally in the variable spacing configuration so that adjacent signal lines on each of the groups of the plurality of signal lines extend away from each other within the predetermined distance with a group of the one or more groups including a first number (x) of signal lines spaced over a width sufficient for at least the first number of signal lines plus two (x+2).

32. A system with reduced forward cross talk, the system comprising:
a backplane; and
a plurality of signal lines routed along generally parallel paths, wherein the plurality of signal lines are divided into one or more groups of signal lines, wherein within each group of the one or more groups of signal lines, the signal lines are spaced unequally in a variable spacing configuration so that adjacent signal lines extend away from each other within a predetermined distance to reduce the forward crosstalk between the adjacent signal lines.

33. The system of claim 32, further comprising:
active terminators coupled to each of the plurality of signal lines.

34. The system of claim 33, wherein the backplane comprises a single strip line stack up.

35. The system of claim 32, wherein the single strip line stack up is asyrnmetrical.

36. The system of claim 35, wherein the single strip line stack up comprises a power plane, a signal line plane, and a ground plane with the signal line plane closest to the ground plane.

37. The system of claim 36, wherein the plurality of signal lines are routed on the signal line plane.

38. The system of claim 32, wherein the backplane comprises a single strip line stack up.

39. The system of claim 38, wherein the single strip line stack up is asymmetrical.

40. The system of claim 39, wherein the single strip line stack up comprises a power plane, a signal line plane, and a ground plane with the signal line plane closest to the ground plane.

41. The system of claim 40, wherein the plurality of signal lines are routed on the signal line plane.

42. The system of claim 32, wherein the plurality of signal lines are routed among connections to one or more active components and one or more passive components.

43. The system of claim 32, wherein the plurality of signal lines are substantially symmetrical about a point of symmetry.

44. The system of claim 32, wherein during operation adjacent signal lines in each group extend away from each other such that less than about 50% of a predetermined induced voltage maximum value is induced on the adjacent signal lines.

45. The system of claim 32, wherein each group includes a first number (x) of signal lines spaced over a width sufficient for at least the first number of signal lines plus one (x+1).

46. The system of claim 32, wherein each group includes a first number (x) of signal lines spaced over a width sufficient for at least the first number of signal lines plus two (x+2).

47. A system with reduced forward crosstalk, the system comprising:
a plane; and
at least three communications links disposed in the plane, each of the at least three communications links generally parallel to an adjacent communications link of the at least three communications links;
wherein each communications link of the at least three communications links is divided into a plurality of segments, with each segment of the plurality of segments and a corresponding segment of the adjacent communications link of the at least three communications links separated by a fixed distance defining a set of segments; and
wherein each pair of adjacent communications links of the at least three communications links includes two or more sets of segments with each set of segments separated by a respective fixed distance with at least two respective fixed distances being different, with a greater one of the with at least two respective fixed distances reducing the forward crosstalk between said each pair of adjacent communications links of the at least three communications links.

48. The system of claim 47, wherein the at least three communications links further comprise transitions between and joining adjacent segments of each communications link of the at least three communications links when the adjacent segments are not contiguous.

49. A method for reducing forward crosstalk between a first signal line and a second signal line, the method comprising:
spacing, for a first run length, the first signal line and the second signal line at a first separation distance, which tends to induce forward crosstalk to a first level per unit length;
spacing, for a second run length, the first signal line and the second signal line at a second separation distance, which tends to induce forward crosstalk to a second level per unit length that is less than the first level per unit length, wherein the second run length at the second separation distance tends to reduce the forward crosstalk; and
spacing, for a third run length, the first signal line and the second signal line at a third separation distance, which tends to induce forward crosstalk to a third level per unit length that is greater than the second level per unit length.
